(19) United States
(12) Patent Application Publication
(10) Pub. No.: US 2010/0160889 A1
(43) Pub. Date: Jun. 24, 2010

(54) VIAL ACCESS SPIKE ASSEMBLY

(75) Inventors: Donald A. Smith, Salem, WI (US); Steven C. Jepson, Vernon Hills, IL (US); Thomas E. Dudar, Palatine, IL (US)

Correspondence Address: MARSHALL, GERSTEIN & BORUN (BAXTER), 233 SOUTH WACKER DRIVE, 6300 WILLIS TOWER, CHICAGO, IL, 60606-6357, US

(73) Assignees: BAXTER INTERNATIONAL INC., Deerfield, IL (US); BAXTER HEALTHCARE S.A., Zurich (CH)

(21) Appl. No.: 12/341,473

(22) Filed: Dec. 22, 2008

(51) Int. Cl. A61J 1/14

(52) U.S. Cl. 604/414; 604/411

(57) ABSTRACT

A spike assembly having an elongate spike defining a hollow cannula that is in fluid communication with the interior of a luer connection portion. The spike assembly provides needleless access to a stopper of a vial to facilitate injection and withdrawal of fluids via a syringe barrel selectively secured to the luer connection portion. The syringe can safely be removed from the spike assembly and then be directly attached to a luer compatible connector. The elongate spike may include a frangible tip portion that can break away from the spike assembly within a vial. The spike assembly may have a neck with a pair of gripping wing members. The spike assembly may have a feature that prevents rotation of the spike in the vial stopper, thereby allowing the syringe to be easily and safely disconnected from the spike assembly without having to grasp the spike assembly.

### FIELD OF THE DISCLOSURE

This application relates generally to devices for gaining access to the contents of vials and, more specifically, to spiked cannulae used to pierce an elastomeric stopper of a vial, and to the provision of a luer engaging member.

### BACKGROUND

In order to deliver the contents of a vial to an intravenous bag or administration set, medical professionals typically first have to puncture the stopper of the vial with a syringe needle disposed on the distal end of a barrel of a syringe, if the contents are lyophilized, then inject a diluent into the vial and reconstitute the contents, draw the contents of the vial up into the syringe barrel, withdraw the syringe needle from the vial stopper, and then re-cap or remove the needle. This procedure is time consuming, involves a number of steps prior to delivery of the vial contents to the intravenous bag or administration set, and exposes medical professionals to sharp syringe needles. While recapping appliances are known, there are still times when the syringe needle is exposed.

Moreover, the introduction of luer compatible connectors on infusion administration sets and flexible bags or containers removes much of the need for a needle to provide fluid connection to these sets or bags. If the syringe is withdrawn from the vial with the attached needle, the needle must be removed prior to connection to these luer compatible connectors.

It would be desirable to provide a system in which a vial stopper may be pierced in a manner that permits the luer end of a typical syringe barrel to be selectively placed into communication with the interior of the vial without the use of a sharp needle, so that, if necessary, a diluent may be injected to reconstitute the contents of the vial, the vial contents may be drawn into the syringe barrel, and the syringe may be disengaged from the vial with only an end configured as a male luer tip to eliminate needle sticks.

### BRIEF DESCRIPTION OF THE SEVERAL VIEWS OF THE DRAWING

FIG. 1 is a cross-sectional view of a connecting portion of a syringe barrel and a spike assembly with a luer connection and a frangible tip;

FIG. 2 is a cross-sectional view of the connecting portion of the syringe barrel and the spike with luer connection and frangible tip of FIG. 1, with the frangible tip of the spike assembly received in a stopper of a vial;

FIG. 3 is a cross-sectional view of the spike with luer connection and frangible tip of FIG. 1;

FIG. 4 is a cross-sectional view similar to FIG. 2, but showing the elongate spike inserted further into the vial stopper, beyond the frangible tip of the spike assembly;

FIG. 5 is a cross-sectional view similar to FIG. 4, showing the frangible tip of the spike broken off from the remainder of the spike assembly with luer connection;

FIG. 6 is a cross-sectional view similar to FIG. 5, showing remainder of the spike assembly, now with a male luer stem, withdrawn from the vial stopper, with the broken-off frangible tip portion remaining in the vial;

FIG. 7 is a perspective view of a spike assembly of an alternate embodiment of the present disclosure;

FIG. 8 is a front plan view of the spike assembly of FIG. 7;

FIG. 9 is a cross-sectional view of the spike assembly of FIG. 7, taken along lines 9-9 of FIG. 7;

FIG. 10 is a cross-sectional view of a connecting portion of the syringe barrel and the spike assembly of FIG. 7, with the elongate spike of the spike assembly received in a stopper of a vial;

FIG. 11 is a perspective view of a spike assembly of a second alternate embodiment of the present disclosure;

FIG. 12 is a perspective view of a spike assembly of a third alternate embodiment of the present disclosure;

FIG. 13 is a plan view of a spike assembly of a fourth alternate embodiment of the present disclosure;

FIG. 14 is a cross-section view of the spike assembly of FIG. 13; and

FIG. 15 is an enlarged cross-sectional view of a rotating luer lock collar of the spike assembly of FIGS. 13 and 14, illustrating the region identified by the broken line 15 in FIG. 14.

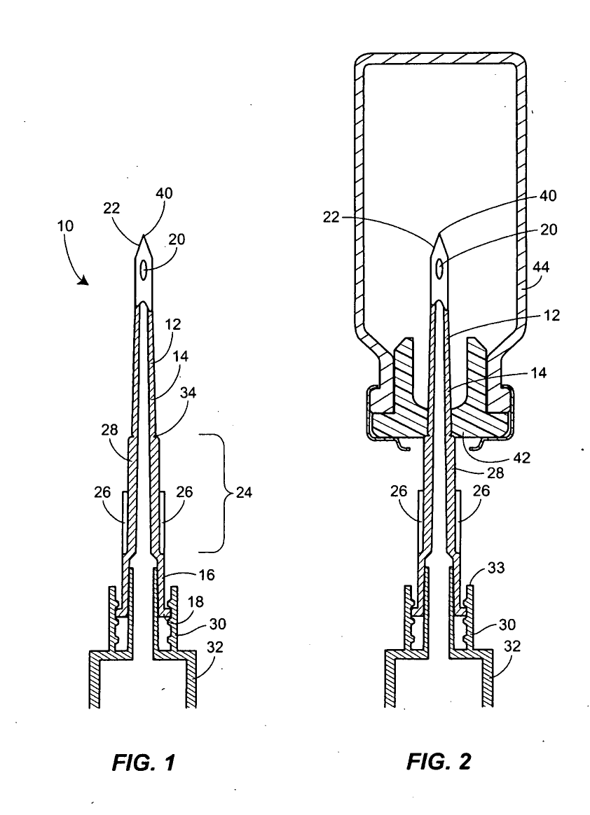

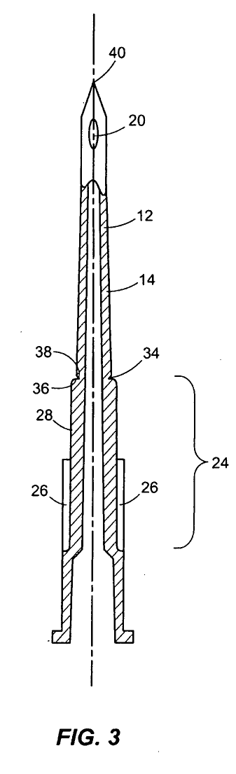

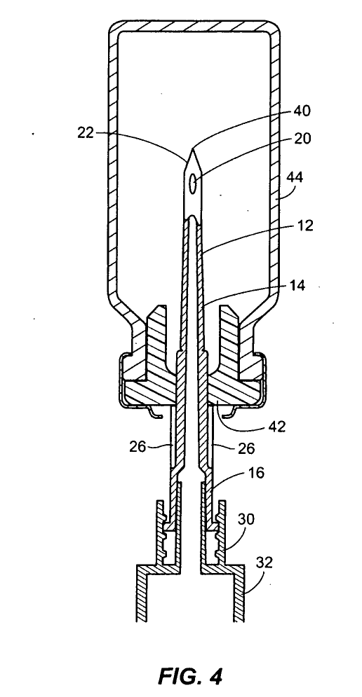

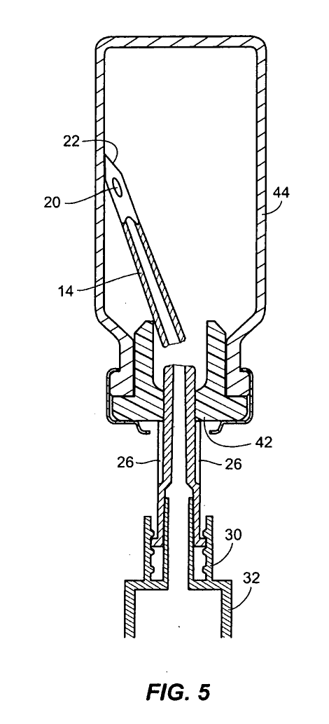

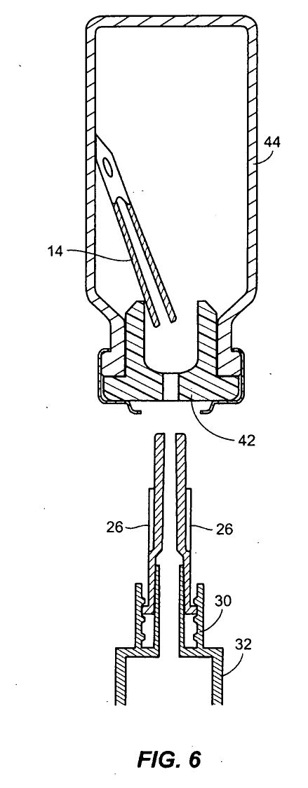

### DETAILED DESCRIPTION OF THE PREFERRED EMBODIMENTS

In a first embodiment of the present disclosure, a spike assembly 10 is provided. The spike assembly 10 includes an elongate spike 12 having a frangible tip portion 14 and a luer connection portion 16 at a proximal end 18 thereof, extending coaxially with the elongate spike 12. The spike assembly 10 defines a hollow cannula with an opening 20 at or adjacent a distal end 22.

The spike assembly 10 preferably includes an intermediate section 24 between the frangible tip portion 14 and the luer connection portion 16 including a plurality of axially-extending ribs 26 that extend from the luer connection portion 16 to a location along the intermediate section 24. An axially-extending region of the intermediate section 24 extending from the axially-extending ribs 26 to the frangible tip portion 14 is referred to herein as a luer stem 28. Preferably, the portion of the luer stem 28 extending proximally from the frangible tip portion 14 is dimensioned, upon removal of the frangible tip portion, to form a male luer configured to engage a standard female luer connection fitting (not shown).

The luer connection portion 16 of the spike assembly 10 is selectively engageable by a luer fitting 30 at the distal end of a syringe barrel 32. The spike assembly 10 preferably has a wall thickness in the luer stem 28 thicker than along the frangible tip portion 14. At an intersection of the frangible tip portion 14 and the luer stem 28, the spike assembly 10 includes an annular reduced-thickness channel 34. The annular reduced-thickness channel 34 provides a weakened location of the spike assembly 10 at which the frangible tip portion 14 may be broken away from the remaining intermediate section 24 and luer connection portion 16. The annular reduced-thickness channel 34 may be v-shaped in cross-section, with a first wall 36 along the luer stem 28 extending perpendicularly to the longitudinal axis of the elongate spike 12, and a second wall 38, along the frangible tip portion 14, preferably forming a 45° angle with the first wall 36, and an apex of the v-shaped annular reduced-thickness channel 34 being radially inwardly of the outer diameters of the luer stem 28 and the frangible tip portion 14.

In use, a sharp point 40 at the distal end 22 the spike assembly 10 is used to pierce a stopper 42 of a vial 44. If the contents of the vial 44 are lyophilized, diluent within the syringe barrel 32 is injected into the vial and the contents are reconstituted. The liquid contents of the vial 44 may then be drawn into the syringe barrel 32 by pulling on a plunger (not shown) received in the syringe barrel 32. The syringe barrel 32 may then be tilted to force the frangible tip portion 14 against an inner wall of the vial 44, and additional force may then be applied to break the frangible tip portion 14 away from the intermediate section 24 of the spike assembly 10 along the annular reduced-thickness channel 34 to expose the luer stem portion 28. The syringe barrel 32 may then be used to withdraw the remaining luer connection portion 16 and intermediate section 24 of the spike assembly 10 from the stopper 42 of the vial 44. The luer stem 28 may now be utilized to directly access a female luer connector (not shown). Such female luer connectors may include luer activating valves or devices on such medical components such as infusion sets or containers, flexible or rigid.

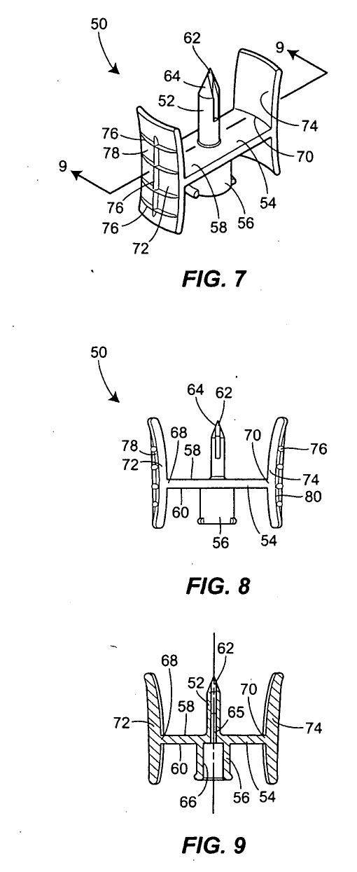

Turning to FIGS. 7-10, a spike assembly 50 of a first alternate embodiment of the present disclosure is illustrated. The spike assembly 50 includes an elongate spike 52, a neck 54 that extends in a plane that is perpendicular to the longitudinal axis of the elongate spike 52, and a luer connection portion 56 disposed on a face of the neck 54 opposite the elongate spike 52. In other words, the elongate spike 52 extends perpendicularly from a first face 58 of the neck 54 of the spike assembly 50, and the luer connection portion 56 extends from a second face 60 of the neck 54, with the neck 54 defining an intermediate section of the spike assembly 50. The elongate spike 52 defines a hollow cannula with a preferably slotted opening 62 at or near a distal end 64 of the spike assembly 50. The hollow cannula defined by the elongate spike 52 is in fluid communication with an aperture 65 through the neck 54, and with the interior 66 of the luer connection portion 56.

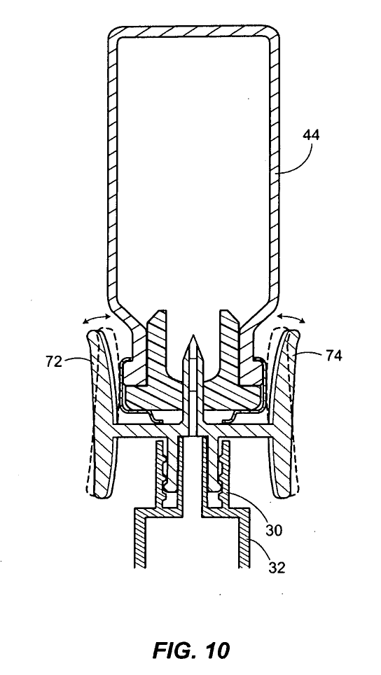

As in the previous embodiment, the luer connection portion 56 is selectively engageable by a luer fitting at the distal end of a syringe barrel, as shown in cross-section in FIG. 10.

The neck 54 includes a first end 68 and a second end 70, equally spaced from the longitudinal axis of the elongate spike 52 on opposite sides of the neck 54. A first gripping wing member 72 is provided at the first end 68 of the neck 54, and a second gripping wing member 74 is provided at the second end 70 of the neck 54. Each of the first and second gripping wing members 72, 74 preferably curves parabolically outwardly, away from the opposing gripping wing member 74, 72, with increasing distance from the neck 54. The parabolic configurations of the first and second gripping wing members 72, 74 allow the wing members to accommodate a variety of sizes of vials and syringe barrels with diameters which may exceed the spacing between the first 68 and second end 70 of the neck.

The gripping wing members 72, 74 serve several functions. One function is to protect the user's fingers from inadvertent contact with the sharp point of the elongate spike 52. A second function is to preserve the sterility of a tip 33 of the syringe luer fitting 30, and the luer connection portion 56 by shielding the users fingers from contact with these elements particularly during attachment and removal of the spike assembly 50 from the syringe. A further function is to allow the wings to be squeezed toward each other as shown particularly in FIG. 10 to provide selective gripping of the top rim of the vial 44 of various sizes. Such gripping engagement facilitates the injection and withdrawal process of fluid into and out of the vial 44 and also allows the spike assembly 50 to be selectively disengaged from the syringe while being embedded in the vial.

The gripping wing members 72, 74 may each be provided with a plurality of ridges 76 on the exterior surface 78, 80 thereof. The ridges 76 enhance gripping the spike assembly 50 to facilitate insertion of the elongate spike 52 into the stopper of a vial, inasmuch as the fingers of the user may be covered by latex or non-latex medical gloves. The gripping wing members 72, 74 may also be used to hold the spike assembly while attaching and/or removing the syringe.

In use, the user withdraws the spike assembly 50 from sterile packaging not shown by gripping the wing members 72, 74. The user then engages the spike assembly 50 to the syringe by interconnection of luer connection portion 56 to the male luer tip of the syringe while maintaining the grip of the wing members 72, 74. The user then engages the interconnected syringe and spike assembly 50 to a vial pushing the elongate spike 52 into the elastomeric stopper of the vial thereby penetrating the vial stopper. The gripping wings 72, 74 may be squeezed to thereby engage the vial. The user may then inject a diluent into the vial if necessary to reconstitute a solid drug and then remove the liquid contents of the vial into the syringe. The user may then twistingly disengage the assembly 50 from the syringe while keeping the elongage spike 52 safely shielded in the interior of the vial. Such disengagement also exposes the luer tip of the syringe which may now be used to form a connection with a female luer connector.

In an embodiment, the gripping wings 72, 74 do not form inwardly extending latching projections opposite the tip 62 which may be utilized to grip beneath the top rim of a vial. These latches may create difficulty in accepting vials having a top rim with a diameter greater than the distance between the inward tips of these latches.

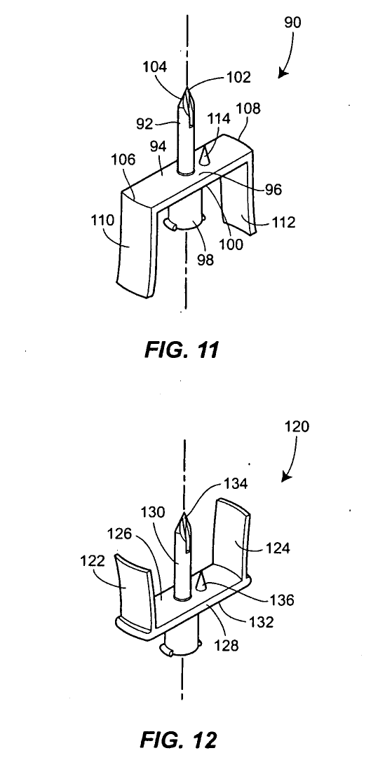

FIG. 11 illustrates a second alternate embodiment of a spike assembly 90 of the present disclosure. Like the spike assembly 50 of the previous embodiment, the spike assembly 90 includes an elongate spike 92 extending from a first face 94 of a neck 96, and a luer connection portion 98 extending from a second face 100 of the neck 96. The elongate spike 92 defines a hollow cannula having a preferably slotted opening 102 at the distal end 104 thereof. The neck 96 has a first end 106 and a second end 108. In the spike assembly 90 of this embodiment, gripping wing members 110, 112 are provided at each of the first and second ends 106, 108 of the neck 96, and the gripping wing members 110, 112 preferably curve away from one another with increasing distance from the plane of the neck 96. However, the gripping wing members 110, 112 only extend from the neck 96 in the direction of the luer connection portion 98. Like spike assembly 90, the gripping wing members 110, 112 serve to prevent the user's fingers from inadvertent contact with the luer connection portion 98 and the tip 33 of the syringe luer fitting 30.

A pointed tang 114 extends from the first face 94 of the neck 96, in the same direction as the elongate spike 92. The pointed tang 114 serves to provide a stabilizing second point of engagement of the spike assembly 90 with a vial stopper. This stabilizing second point of engagement is off-center, i.e. spaced from the longitudinal axis of the elongate spike 92, to prevent rotation of the spike assembly 90 when the syringe is rotated counterclockwise to effect disengagement with the spike assembly. The user only needs to grip the vial and syringe, thereby avoiding contact with the spike assembly.

In FIG. 12, a third alternate spike assembly 120 of the present disclosure is illustrated. This embodiment is similar to the spike assembly 90, but the gripping wing members 122, 124 extend from a first face 126 of the neck 128, in the direction of the elongate spike 130, rather than from a second face 132. Like the spike assembly 90, the gripping wing members 122, 124 of the spike assembly 120 provide some protection to the user's fingers from the sharp tip 134 of the elongate spike 130, as well as from the pointed tang 136, which provides a stabilizing second point of engagement of the spike assembly 120 with a vial stopper. The size of gripping wing members 110, 112 may be limited by syringe size, whereas the size of griping wing members 122, 124 may be limited by vial size. Referring to FIGS. 7 and 12, it should be noted that the tang 136 may also be included on the spike assembly 50 by being formed on the neck 54 on one or both sides of the elongate spike 52.

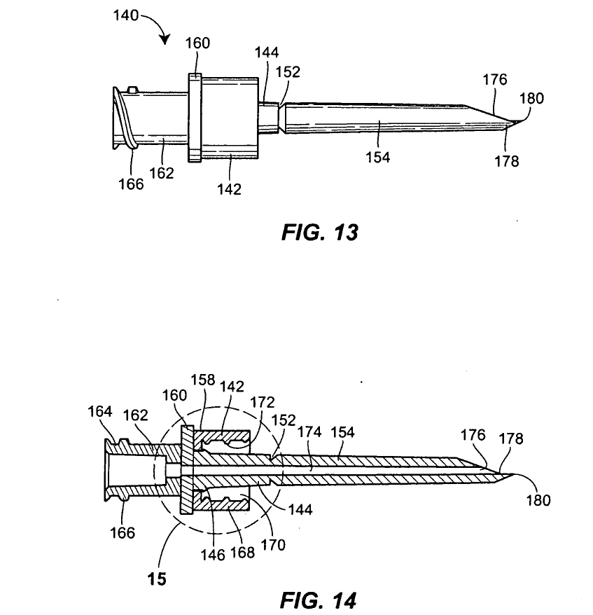

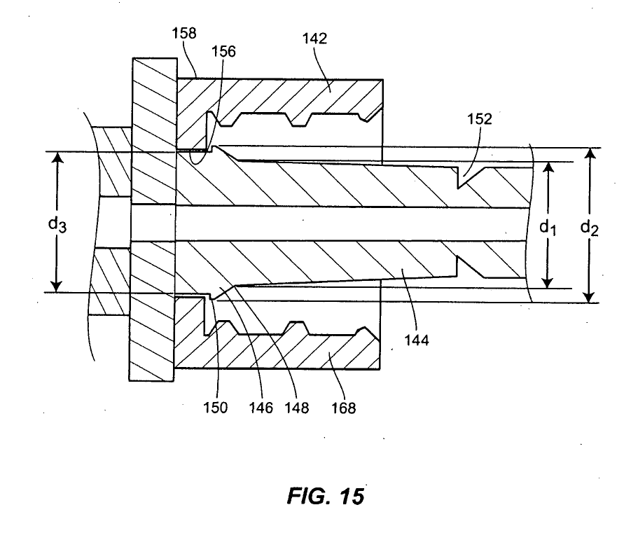

Turning now to FIGS. 13-15, a fourth alternate spike assembly 140 of the present disclosure is similar to the spike assembly 10 of the first embodiment, but is provided with a rotating luer lock collar 142. Along the intermediate section 144 of the spike assembly 140, an annular frustoconical locking projection 146 is provided. The annular frustoconical locking projection 146 has a distal end 148 of a first diameter d₁, and a proximal end 150 of a second, larger diameter d₂. The intermediate section 144 of the spike assembly 140 preferably tapers inwardly from the distal end 148 of the annular frustoconical locking projection 144 to an annular reduced-thickness channel or stepped section 152 that provides a weakened portion of the spike assembly 140, between the intermediate section 144 and the frangible tip portion 154.

The second diameter d₂ is at least slightly greater than the diameter of an axially-extending locking bore 156 provided at a proximal end 158 of the rotating luer lock collar 142. The intermediate section 144 of the spike assembly 140 has a constant diameter d₃ between the distal end 148 of the annular frustoconical locking projection 146 and a neck portion 160 disposed between the intermediate section 144 and a luer connection portion 162 at a proximal end 164 of the spike assembly 140. The diameter d₃ is less than the second diameter d₂ and at least slightly less than the diameter of the axially-extending locking bore 156 at the proximal end 158 of the rotating luer lock collar 142. As a result, the rotating luer lock collar 142 is rotatably secured onto the intermediate section 144 of the spike assembly 140 by inserting the frangible tip portion 154 into the axially-extending locking bore 156 of the rotating luer lock collar 142, pushing the axially-extending locking bore 156 of the rotating luer lock collar 142 over the annular frustoconical locking projection 146 until the axially-extending locking bore 156 passes the proximal end 150 of the annular frustoconical locking projection 148.

The luer connection portion 162 of the spike assembly 140 may be provided with one or more threads, such as male threads 166, to provide threaded securement of a syringe barrel (not shown) with complementary female threads to the spike assembly 140. The sidewall 168 of the rotating luer lock collar 142 defines an axially-extending cavity 170. The cavity 170 may be provided with one or more threads, such as male threads 172, to secure a female luer (not shown) within the cavity 170. The ability to rotate the luer lock collar 142 facilitates selective securement of the male threads 172 within complementary female threads of such a female luer.

An axially-extending bore 174 in the form of a hollow cannula extends substantially the entire length of the needle assembly 140, from the luer connection portion 162 to an opening 176 at a distal end 178 of the spike assembly 140. The spike assembly 140 terminates at a sharp tip 180 provided at the distal end 178.

While various embodiments have been described herein, it will be understood that variations can be made to the disclosed embodiments that are still within the scope of the following claims.

We claim:

1. A spike assembly comprising:
an elongate spike having a proximal end and a sharp point at a distal end and defining a hollow cannula;
a luer connection portion arranged coaxially with the elongate spike; and
an intermediate portion extending between the proximal end of the elongate spike and the luer connection portion.

2. The spike assembly of claim 1, wherein the intermediate portion includes a plurality of ribs extending from the luer connection portion toward the proximal end of the elongate spike.

3. The spike assembly of claim 2, wherein the intermediate portion includes a luer stem extending from the proximal end of the elongate spike to the plurality of ribs.

4. The spike assembly of claim 1, including an annular reduced-thickness channel at an intersection of the intermediate portion and the proximal end of the elongate spike.

5. The spike assembly of claim 4, wherein the annular reduced-thickness channel is v-shaped in cross-section.

6. The spike assembly of claim 1 wherein the intermediate section includes a neck having a first face from which the elongate spike extends and a second face from which the luer connection portion extends, and an aperture therethrough, an interior of the luer connection portion and the aperture being in fluid communication with the hollow cannula of the elongate spike.

7. The spike assembly of claim 6, including a first gripping wing member disposed at a first end of the neck and a second gripping wing member disposed at a second end of the neck.

8. The spike assembly of claim 7, wherein the first and second gripping wing members generally parabolically curve away from one another with increasing distance from the neck.

9. The spike assembly of claim 7, wherein the first and second gripping wing members extend from the neck in a direction toward only one of the elongate spike or the luer connection portion.

10. The spike assembly of claim 7, wherein each of the first and second gripping wing members includes a plurality of ridges on an outer surface thereof.

11. The spike assembly of claim 6, including a pointed tang extending from the first face of the neck and spaced from the longitudinal axis of the elongate spike.

12. The spike assembly of claim 1, further comprising a neck portion disposed between the integral portion and the luer connection portion, and wherein the intermediate portion further comprises an annular frustoconical locking projection having a distal end of a first diameter and a proximal end of a second diameter greater than the first diameter, the distal end of the annular frustoconical locking projection being spaced apart from the neck portion by a region of the intermediate portion having a constant diameter that is of a third diameter that is less than the second diameter.

13. The spike assembly of claim 12, further comprising a rotatable luer lock collar received on the intermediate portion, the rotatable luer lock collar including an axially-extending locking bore therethrough, the axially-extending locking bore having a diameter that is at least slightly greater than the third diameter and at least slightly less than the second diameter.

14. A spike assembly comprising:
a neck having an aperture therein;
an elongate spike having a proximal end and a sharp point at a distal end and defining a hollow cannula, the elongate spike extending from a first face of the neck;
a luer connection portion extending from a second face of the neck, the luer connection portion arranged coaxially with the elongate spike and having an interior portion in fluid communication with the aperture of the neck and the hollow cannula of the elongate spike;
a first gripping wing member disposed at a first end of the neck;
a second gripping wing member disposed at a second end of the neck; and
a pointed tang extending from the first face of the neck and spaced from a longitudinal axis of the elongate spike.

15. The spike assembly of claim 14, wherein each of the first and second gripping wing members includes a plurality of ridges on an outer surface thereof.

16. The spike assembly of claim 14, wherein the first and second gripping wing members curve away from one another with increasing distance from the neck.

17. The spike assembly of claim 14, wherein the first and second gripping wing members extend from the neck in a direction toward only one of the elongate spike or the luer connection portion.

18. The spike assembly of claim 14, wherein the hollow cannula has a slotted opening at a distal end of the elongate spike.

19. A method of withdrawing the contents of a vial comprising:
engaging a vial access assembly to a syringe, the vial access assembly including a neck having an aperture therein, an elongate spike having a proximal end and a sharp point at a distal end and defining a hollow cannula, the elongate spike extending from a first face of the neck, a luer connection portion extending from a second face of the neck, the luer connection portion arranged coaxially with the elongate spike and having an interior portion in fluid communication with the aperture of the neck and the hollow cannula of the elongate spike, a first gripping wing member disposed at a first end of the neck, a second gripping wing member disposed at a second end of the neck;
penetrating a stopper of a vial spike and grippingly engaging the vial with the first and second wing members;
injecting contents of the syringe into the vial;
withdrawing the contents of the vial;
disengaging the vial access assembly from the syringe while maintaining the penetration of the stopper by the vial spike; and
attaching a luer tip of the syringe to a female luer connector and injecting the contents withdrawn from the vial into the syringe into the connector.
